(19) United States
(12) Patent Application Publication
(10) Pub. No.: US 2022/0045382 A1
(43) Pub. Date: Feb. 10, 2022

(54) BATTERY CELL EMBEDDED WITH HEATING SHEET

(71) Applicants: Hyundai Motor Company, Seoul (KR); Kia Corporation, Seoul (KR)

(72) Inventors: Sang-Ha Lee, Suwon-si (KR); Jee-Jung Kim, Yongin-si (KR)

(21) Appl. No.: 17/318,713

(22) Filed: May 12, 2021

(30) Foreign Application Priority Data
Aug. 6, 2020 (KR) 10-2020-0098802

(51) Int. Cl. H01M 10/653; H01M 10/615; H01M 10/48; H01M 10/42; H01M 10/635

(52) U.S. Cl. CPC H01M 10/653; H01M 10/615; H01M 2010/4271; H01M 10/425; H01M 10/635; H01M 10/486

(57) ABSTRACT

A battery cell includes: an inner wall; battery electrodes; a separator; a battery cell; and a heating sheet. The heating sheet may have a structure including a heating unit and insulating films. The heating unit may include a heating element and heating unit electrodes, and the heating sheet may be positioned between the two adjacent battery electrodes or positioned between an outermost battery electrode and the inner wall.

### CROSS-REFERENCE TO RELATED APPLICATIONS

This application claims the benefit of priority to Korean Patent Application No. 10-2020-0098802, filed on Aug. 6, 2020, in the Korean Intellectual Property Office, the disclosure of which is incorporated herein by reference in its entirety.

### TECHNICAL FIELD

The present disclosure relates to a battery cell embedded with a heating sheet, and more particularly, to a battery cell, in which a heating sheet positioned in the battery cell maintains a predetermined temperature or higher of a battery pack, thereby allowing a vehicle to start smoothly and improving battery efficiency.

### BACKGROUND

A lithium rechargeable battery has a problem in that the performance, particularly, the output performance deteriorates at a low temperature. In order to solve the problem of the deterioration in performance at a low temperature, a structure, in which a heating sheet is mounted outside a battery cell, and a control system has been introduced.

The related art is related to the heating sheet mounted outside the battery cell for batteries of electric vehicles, for the purpose of adjusting a temperature of the battery cell to a reference temperature within several hundreds of seconds. As a result, the related art is not suitable for starting batteries which need to be operated within 10 seconds.

Accordingly, an idea of quickly raising an internal temperature of a battery cell by disposing a heating sheet in the battery cell has been proposed, but this configuration has a problem in that the heating sheet interferes with a movement of an electrolyte or causes a chemical side reaction.

The information included in this Background section is only for enhancement of understanding of the general background of the present disclosure and may not be taken as an acknowledgement or any form of suggestion that this information forms the prior art already known to a person skilled in the art.

### SUMMARY

The present disclosure has been made in an effort to provide a battery cell, in which a heating sheet is positioned in the battery cell to adjust a temperature of the battery cell to a reference temperature within 10 seconds, the heating sheet has a porous structure and thus does not interfere with a movement of an electrolyte, and an insulating layer is mounted on a surface of a heating unit to prevent the occurrence of a side reaction, such that the battery cell is suitable for a battery for starting a vehicle.

Technical problems to be solved by the present disclosure are not limited to the above-mentioned technical problems, and other technical problems, which are not mentioned above, may be clearly understood from the following descriptions by those skilled in the art to which the present disclosure pertains.

In order to achieve the above-mentioned object, the battery cell embedded with a heating sheet according to the present disclosure includes: an inner wall; battery electrodes; a separator; a battery cell; and a heating sheet. The heating sheet may have a structure including a heating unit and insulating films. The heating unit may include a heating element and heating unit electrodes, and the heating sheet may be positioned between the two adjacent battery electrodes or positioned between an outermost battery electrode and the inner wall.

The heating unit electrode may be made of a metallic material having excellent conductivity, and particularly, the metallic material may be selected from a group consisting of gold, silver, copper, nickel, aluminum, platinum, palladium, tin, zinc, iron, lead, or an alloy thereof.

The heating element may be made of a carbon material or a metallic material. In the case in which the heating element is made of a carbon material, the carbon material may be a combination of a polymer binder for attachment and a carbon material selected from a group consisting of CNT, graphite, carbon black, graphene, CNF, and a combination thereof.

The carbon heating element may have a pattern and be coated. In this case, the pattern may be implemented as various patterns such as a horizontal pattern, a vertical pattern, and a complex pattern. Meanwhile, the heating element may be coated with an insulating film, and a ratio of an area of the heating element to an area of the insulating film may be designed to be 10% or more and 90% or less.

In a case in which the heating sheet is positioned between a positive electrode and a negative electrode of the battery, the heating sheet needs to include the insulating film in order to cut off direct contact with the electrodes, and the insulating film needs to have a porous structure. The insulating film may be made of a material having low conductivity, and particularly, made of any one selected from a group consisting of polymer, ceramic, and a composite thereof.

In a case in which the heating element is made of a metallic material, the metallic material may be selected from a group consisting of iron, copper, tungsten, nickel, chromium, and an alloy thereof. In addition, the metallic material may be coated with a polymer, and the polymer may be any one selected from a group consisting of PE, PI, PP, PET, and nylon having insulation.

According to the present disclosure configured as described above, the heating sheet is positioned in the battery cell, such that it is possible to utilize the lithium ion battery as a starting battery even in cold weather (at a low temperature). Unlike the disclosure in the related art in which the heating sheet is positioned outside the battery cell such that the temperature of the battery cell reaches the reference temperature within several hundreds of seconds, the system and the structure of the battery cell proposed by the present disclosure quickly increase the internal temperature of the battery cell, thereby quickly activating the starting function even in a low-temperature environment.

In addition to the starting performance, the charging performance and the charging efficiency of the lithium ion battery also deteriorate at a low temperature. Therefore, the raising of the temperature of the battery cell within a short time improves the performance of the lithium ion battery, while the vehicle travels, while ensuring the starting function, thereby improving energy efficiency.

### BRIEF DESCRIPTION OF THE DRAWINGS

The following accompanying drawings are provided to help understand the present disclosure, and exemplary embodiments of the present disclosure are provided together with the detailed description. However, technical features of the present disclosure are not limited to the particular drawings, and the features illustrated in the respective drawings may be combined to constitute a new exemplary embodiment.

FIG. 1 is a cross-sectional view of a battery cell embedded with a heating sheet according to an exemplary embodiment of the present disclosure.

FIG. 2 is an enlarged view of the heating sheet illustrated in FIG. 1.

FIG. 3 is a view illustrating a heating unit in which a heating element according to the exemplary embodiment of the present disclosure is made of a carbon material.

FIG. 4 is a view illustrating a heating unit in which a heating element according to the exemplary embodiment of the present disclosure is made of a metallic material.

FIG. 5A is a view illustrating a pattern of the heating element made of a carbon material according to the exemplary embodiment of the present disclosure.

FIG. 5B is a view illustrating a pattern of a heating element made of a carbon material according to another exemplary embodiment of the present disclosure.

FIG. 5C is a view illustrating a pattern of a heating element made of a carbon material according to still another exemplary embodiment of the present disclosure.

FIG. 5D is a view illustrating a pattern of a heating element made of a carbon material according to yet another exemplary embodiment of the present disclosure.

FIG. 6 is a view schematically illustrating a configuration of a system for controlling the battery cell embedded with a heating sheet according to the exemplary embodiment of the present disclosure.

FIG. 7A is a view illustrating a state in which the heating sheet of the battery cell in the system for controlling the battery cell embedded with a heating sheet according to the exemplary embodiment of the present disclosure is connected.

FIG. 7B is a view illustrating a state in which the heating sheet is disconnected.

FIG. 8 is a graph illustrating a change in temperature while the battery cell embedded with a heating sheet according to the exemplary embodiment of the present disclosure operates.

FIG. 9A is a graph illustrating starting performance of the battery cell according to the exemplary embodiment of the present disclosure.

FIG. 9B is a graph illustrating an enlarged part of a predetermined voltage section illustrated in FIG. 9A.

### DETAILED DESCRIPTION OF THE EMBODIMENTS

Hereinafter, the present disclosure will be described in detail with reference to the accompanying drawings. However, the present disclosure is not restricted or limited by exemplary embodiments. Like reference numerals indicated in the respective drawings refer to members which perform substantially the same functions.

An object and an effect of the present disclosure may be naturally understood or may become clearer from the following description, and the object and the effect of the present disclosure are not restricted only by the following description. In addition, in the description of the present disclosure, the specific descriptions of publicly known technologies related with the present disclosure will be omitted when it is determined that the specific descriptions may unnecessarily obscure the subject matter of the present disclosure.

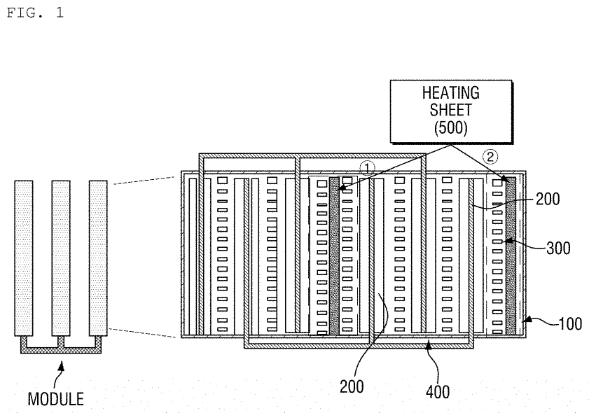

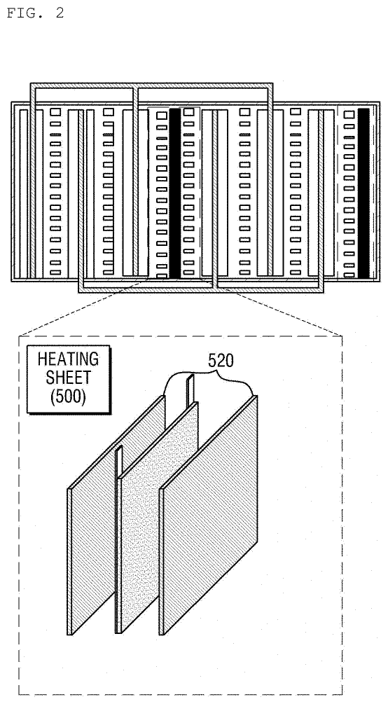

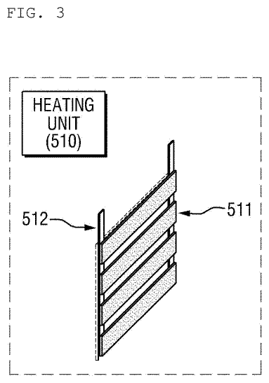

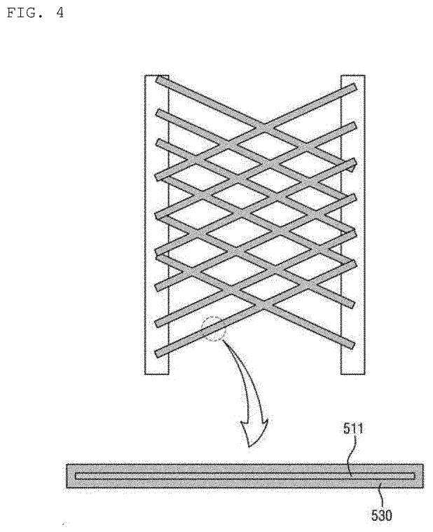

FIG. 1 is a cross-sectional view of a battery cell embedded with a heating sheet according to an exemplary embodiment of the present disclosure, FIG. 2 is an enlarged view of the heating sheet illustrated in FIG. 1, FIG. 3 is a view illustrating a heating unit in which a heating element according to the exemplary embodiment of the present disclosure is made of a carbon material, and FIG. 4 is a view illustrating a heating unit in which a heating element according to the exemplary embodiment of the present disclosure is made of a metallic material.

As illustrated in FIG. 1, a battery cell embedded with a heating sheet according to an exemplary embodiment of the present disclosure may include a battery cell 400 and heating sheets 500.

A material constituting the battery cell may be aluminum or a polymeric composite material in consideration of thermal conductivity and a reduction in weight. An internal space surrounded by sidewalls is formed in the battery cell.

The battery cell 400 includes an electrode assembly having a positive electrode, a negative electrode, and a separator 300 disposed between the positive electrode and the negative electrode, and an electrolyte received in the internal space. In the exemplary embodiment of the present disclosure, electrode assemblies are disposed at predetermined intervals in the internal space of the battery cell 400. In this case, an electrode of the electrode assembly, which is closest to the inner wall 100 of the battery cell 400, is defined as an outermost battery electrode. The plurality of battery cells 400 may be provided and constitute a module. In this case, the respective battery cells 400 may be arranged in series or in parallel so as to be adjacent to one another.

In the battery cell, at least one heating sheet 500 may be disposed or the plurality of heating sheets 500 may be disposed corresponding to the maximum number of electrodes, as necessary. Referring to FIG. 2, the heating sheet 500 may be disposed between the two adjacent electrode assemblies or between the outermost battery electrode and the inner wall 100 of the battery cell 400. In a case in which the heating sheet is disposed in the battery cell, it is necessary to cut off electrical contact between the electrode assembly and the heating sheet 500. Therefore, as illustrated in FIG. 1, the separators 300 need to be provided on both surfaces of the heating sheet 500 in a case in which the heating sheet 500 is disposed between the two adjacent electrode assemblies, and the separator 300 needs to be provided on only one surface of the heating sheet 500 in a case in which the heating sheet 500 is disposed between the outermost battery electrode and the inner wall 100 of the battery cell 400.

The heating sheet 500 includes a heating unit 510 capable of generating heat, and insulating films 520 with which the heating unit 510 is coated. In this case, the heating unit 510 includes a heating element 511 and heating unit electrodes 512.

The heating unit electrodes 512 include a positive (+) electrode and a negative (−) electrode. In this case, the positive (+) electrode and the negative (−) electrode are configured to be spaced apart from each other at a predetermined distance. The heating unit electrode 512 is made of a metallic material having excellent conductivity and the metallic material may be selected from a group consisting of gold, silver, copper, nickel, aluminum, platinum, palladium, tin, zinc, iron, lead, and an alloy thereof.

Referring to FIGS. 3 and 4, the heating element 511 is attached to the heating unit electrodes 512. Therefore, heat is generated when power is applied to the heating unit electrodes 512. The heating element 511 may be made of a carbon material or a metallic material.

In the case in which the heating element 511 is made of a carbon material, the carbon material of the heating element 511 may include carbon nanotube (hereinafter, referred to as ‘CNT’), graphite, carbon black, graphene, carbon nano fibers (hereinafter, referred to as ‘CNF’), and a combination of any one of these composites and a polymer binder. In this case, the polymer binder may include, but not limited to, an epoxy-based material, a cellulose-based material, an acrylic-based material, a vinyl chloride-based material, an acetic acid vinyl-based material, a polyvinyl alcohol-based material, a polyurethane-based material, or a polyester-based material, and the polymer binder may be made of materials well known in the technical field.

In the case in which the heating element 511 is made of a metallic material, the heating element 511 itself may be coated with a polymeric material in order to improve an insulating effect. Referring to FIG. 4, the heating element 511 is surrounded by an insulating polymer 530. In this case, the insulating polymer 530 may be selected from the group consisting of polyethylene (PE), polyamide (PI), polypropylene (PP), polyethylene terephthalate (PET), and nylon.

When the heating unit 510 and the electrode of the electrode assembly are in electrical contact with each other, a chemical side effect may occur. The insulating film 520 is provided to prevent the chemical side effect and stacked and applied onto the heating element 511. The insulating film 520 has a predetermined thickness and porosity to facilitate movements of the electrolyte or ions. In this case, if the thickness of the insulating film is too large or the porosity is low, the ionic migration is restricted, and in the opposite case, the electrode of the electrode assembly and the heating element 511 come into contact with each other, which may cause a short circuit. An exemplary thickness and porosity of the insulating film 520 will be described below.

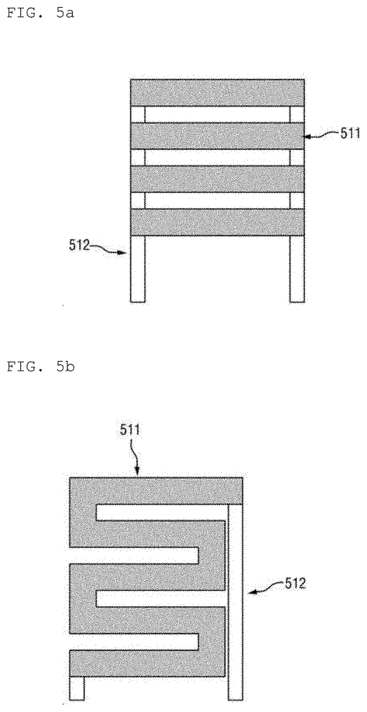

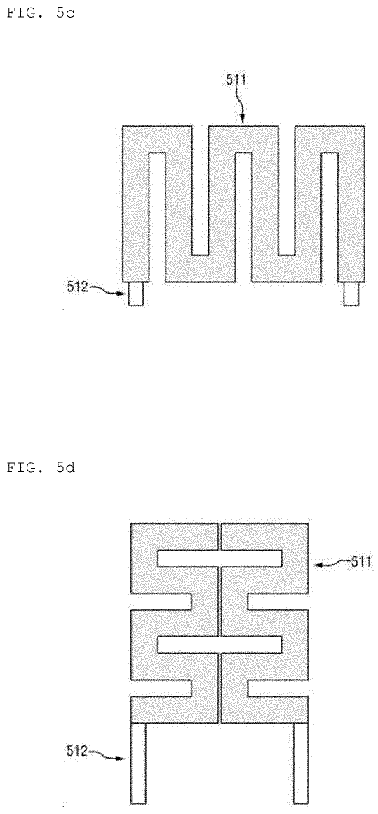

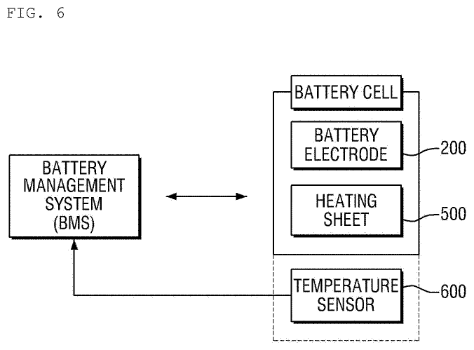

FIG. 5A is a view illustrating a pattern of the heating element made of a carbon material according to the exemplary embodiment of the present disclosure, FIG. 5B is a view illustrating a pattern of a heating element made of a carbon material according to another exemplary embodiment of the present disclosure, FIG. 5C is a view illustrating a pattern of a heating element made of a carbon material according to still another exemplary embodiment of the present disclosure, and FIG. 5D is a view illustrating a pattern of a heating element made of a carbon material according to yet another exemplary embodiment of the present disclosure.

In the case in which the heating element 511 is made of a carbon material, the heating element 511 may have a predetermined pattern and be attached to the heating unit electrodes 512. In this case, the pattern of the heating element 511 may be formed in various ways.

As illustrated in FIGS. 5A and 5B, when a pattern of the heating element 511 is formed, there are formed paths of the heating elements 511, and vacant paths positioned between the paths of the heating elements 511.

Referring to FIG. 5A, the plurality of heating elements 511 is provided and attached to the heating unit electrodes 512 so as to traverse the heating unit electrodes 512. In this case, the pattern of the heating elements 511 is formed so that the paths of the heating elements 511 and the vacant paths are alternately disposed in parallel.

The heating elements 511 may be continuously formed while including curved shapes so that the heating elements 511 are easily attached to the heating unit electrodes 512. In this case, the pattern of the heating elements 511 may be formed so that the paths of the heating elements 511 are connected along the curved shapes. For example, the single heating element 511, which has a horizontal pattern as illustrated in FIG. 5B or a vertical pattern as illustrated in FIG. 5C, may be formed and attached to the heating unit electrodes 512. Alternatively, as illustrated in FIG. 5D, the two heating elements 511 each having a horizontal pattern may be attached to the heating unit electrodes 512, respectively. However, the above-mentioned patterns of the heating elements 511 are merely examples, and the heating elements 511 may have various patterns.

Even in the case in which the heating element 511 is made of a metallic material, the heating element 511 may have a predetermined pattern and be attached to the heating unit electrodes 512. In this case, the pattern of the heating element 511 may be formed in various ways. Referring to FIG. 4, the heating element 511 having a lattice pattern is attached to the heating unit electrodes 512.

As described above, the heating element 511 is coated with the insulating films 520. In this case, a ratio of an area of the heating element 511 to an area of the insulating film 520 may be calculated. In this case, the area of the heating element 511 means an area of the path of the heating element 511. In the exemplary embodiment of the present disclosure, the ratio of the area of the heating element 511 to the area of the insulating film 520 may be 10% or more and 90% or less.

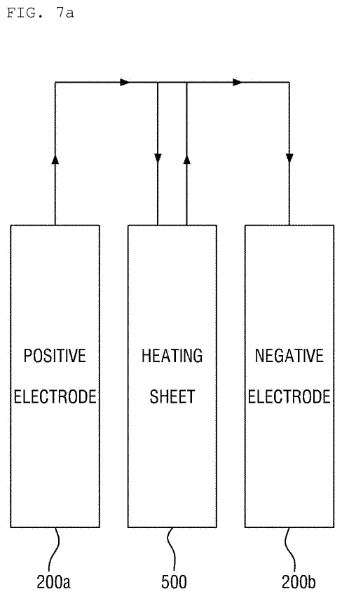

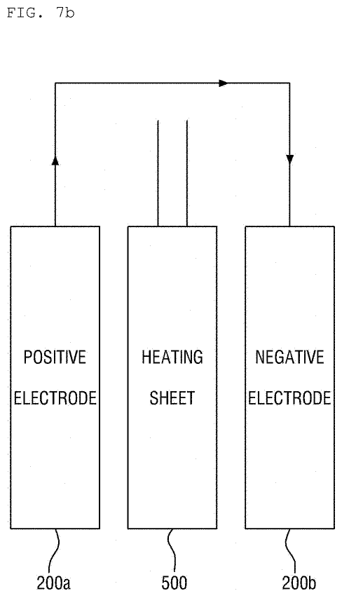

FIG. 6 is a view schematically illustrating a configuration of a system for controlling the battery cell embedded with a heating sheet according to the exemplary embodiment of the present disclosure, FIG. 7A is a view illustrating a state in which the heating sheet of the battery cell in the system for controlling the battery cell embedded with a heating sheet according to the exemplary embodiment of the present disclosure is connected, and FIG. 7B is a view illustrating a state in which the heating sheet is disconnected.

Referring to FIG. 6, the system for controlling the battery cell embedded with a heating sheet according to the exemplary embodiment of the present disclosure may include a battery cell, a temperature sensor 600, and a battery management system (hereinafter, referred to as a ‘BMS’).

The battery cell includes battery electrodes 200 and a heating sheet 500. The battery electrodes 200 may mean electrode assemblies and include a positive electrode assembly 200a and a negative electrode assembly 200b. An electrical connection relationship between the battery electrodes 200 and the heating sheet 500 will be described with reference to FIGS. 7A and 7B. The heating sheet 500 is positioned between the positive electrode assembly 200a and the negative electrode assembly 200b, the positive electrode assembly 200a and the heating sheet 500 are connected with a conductive wire, and the negative electrode assembly 200b and the heating sheet 500 are connected with a conductive wire. In this case, the BMS may perform control to connect or disconnect the heating sheet 500 and the electrode assemblies 200a and 200b.

The temperature sensor 600 senses a temperature in the battery cell. The temperature sensor 600 may be positioned in the battery cell or positioned on an outer surface of the battery cell.

The BMS is connected to the battery cell and the temperature sensor 600. The system BMS receives a sensed value from the temperature sensor 600 and operates the battery electrode 200 or the heating sheet 500 or stops the operations of the battery electrode 200 or the heating sheet 500 based on a condition of the internal temperature of the battery cell.

Hereinafter, an operation mechanism of the battery cell embedded with a heating sheet according to the present disclosure will be described with reference to FIGS. 7A and 7B.

A lithium rechargeable battery may be used as the battery cell according to the exemplary embodiment of the present disclosure. However, because an organic solvent, which is used as an electrolyte of the lithium rechargeable battery, has low ionic conductance at a low temperature, the performance (starting performance and charging performance, etc.) of the lithium rechargeable battery inevitably deteriorates at a low temperature. In the related art, because the heating sheet is mounted outside the battery cell, the temperature of the battery cell cannot be increased within a short time. Therefore, according to the present disclosure, the heating sheet 500 is mounted in the battery cell to increase a temperature to a reference temperature within a short time, thereby improving the performance of the battery.

The operation mechanism of the battery cell embedded with a heating sheet according to the present disclosure includes a heating step and a starting step in accordance with a temperature of the battery cell.

The heating step is a step that is performed when the temperature of the battery cell is lower than a predetermined reference temperature. Referring to FIG. 7A, the BMS receives a sensed value from the temperature sensor 600 and allows a current to flow through the battery cell whether the current temperature of the battery cell is lower than the reference temperature. In this case, because the heating sheet 500 and the electrode assemblies 200a and 200b are connected to each other, the heating sheet 500 operates, such that the temperature of the battery cell is increased. The operating time of the heating step may be 0.1 second to maximum of 10 minutes in accordance with the temperature of the battery cell. In this case, in consideration of a drop of the voltage of the battery, the amount of current is set to be 0.5 C or less in comparison with the capacity of the battery.

The starting step is a step that is performed when the temperature of the battery cell reaches the reference temperature after the heating step. Referring to FIG. 7B, the BMS receives a sensed value from the temperature sensor 600 and disconnects the heating sheet 500 and the electrode assemblies 200a and 200b when the current temperature of the battery cell reaches the reference temperature. Then, the current flows directly from the positive electrode assembly 200a to the negative electrode assembly 200b without flowing through the heating sheet 500. In this case, a start motor may operate to start an engine.

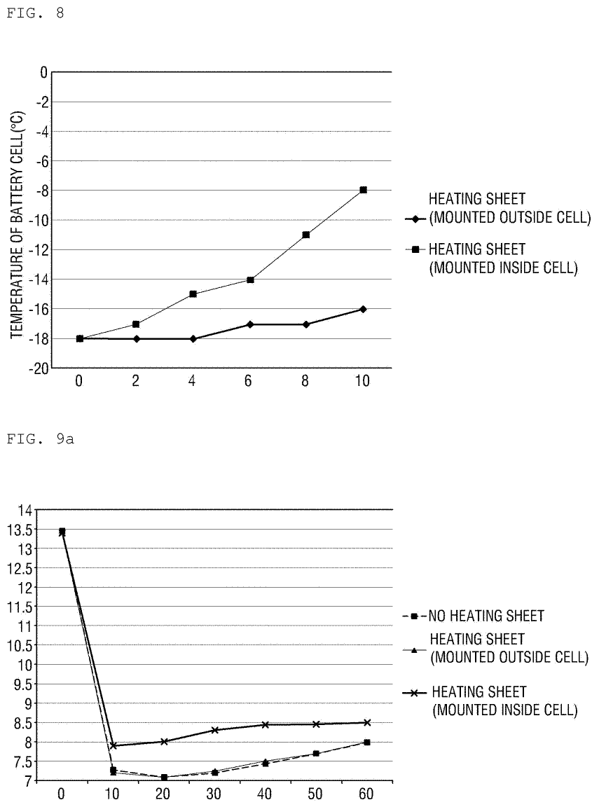

FIG. 8 is a graph illustrating a change in temperature while the battery cell embedded with a heating sheet according to the exemplary embodiment of the present disclosure operates. In this case, the x-axis means a heating time t, and the y-axis means a temperature (° C.) of the battery cell.

The evaluation experiment, which was performed as illustrated in FIG. 8, is a test for checking a change in temperature of the battery cell according to the present disclosure.

The battery cell according to the exemplary embodiment of the present disclosure was manufactured to have a capacity of 15 Ah. The evaluation experiment, which was performed as illustrated in FIG. 8, was performed by comparing Case 1-1 in which the heating sheet 500 was mounted in the battery cell and Case 1-2 in which the two heating sheets were mounted on both sides at the outer periphery of the battery cell. In this case, the two heating sheets 500 were mounted between the outermost battery electrode and the inner wall 100 of the battery cell 400. The process of the evaluation experiment, which was performed as illustrated in FIG. 8, will be described. The heating sheet 500 was operated in a state in which the battery was fully charged at room temperature and then left unattended for 24 hours at a low temperature of −18° C. The measurement of the temperature of the battery cell was performed by checking the voltage of the battery while discharging the battery cell for one minute with a current of 650 A.

Referring to FIG. 8, it can be ascertained that within the heating time of 0 second to 10 seconds, the temperature of the battery cell was increased by 10° C. from −18° C. to −8° C. in Case 1-1, whereas the temperature of the battery cell was increased by 2° C. from −18° C. to −16° C. in Case 1-2. Consequently, it can be seen that an effect of increasing the temperature of the battery cell is better in Case 1-1 than in Case 1-2.

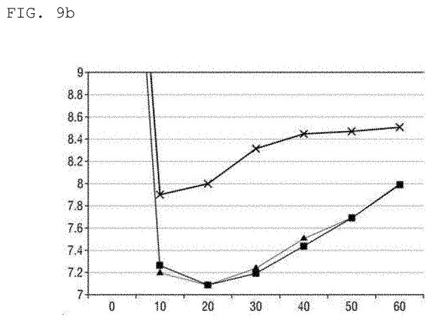

FIG. 9A is a graph illustrating the starting performance of the battery cell according to the exemplary embodiment of the present disclosure, and FIG. 9B is a graph illustrating an enlarged part of a predetermined voltage section (7 V to 9 V) illustrated in FIG. 9A. In this case, the x-axis means the discharge time t, and the y-axis means the battery voltage V.

In this case, the battery cell according to the exemplary embodiment of the present disclosure was manufactured to have a capacity of 15 Ah, and a battery pack of 12 V and 60 Ah was manufactured by using the battery cell. The evaluation experiment, which was performed as illustrated in FIG. 9A, was performed by comparing Case 2-1 in which no heating sheet 500 is mounted, Case 2-2 in which the heating sheet 500 is mounted outside the battery cell, and Case 2-3 in which the heating sheet 500 is mounted inside the battery cell. The process of the evaluation experiment, which was performed as illustrated in FIG. 8, will be described. The heating sheet 500 was operated in a state in which the battery was fully charged at room temperature and then left unattended for 24 hours at a low temperature of −18° C. The checking of the voltage of the battery was performed while discharging the battery for one minute with a current of 650 A.

In order to operate the starting function of the battery, a specific voltage, for example, 7.2 V or higher needs to be maintained when a high current is discharged. If the voltage is decreased to be equal to or lower than this voltage, electrical components in the vehicle may have abnormality.

The following Table 1 shows the results of the evaluation experiment performed as illustrated in FIGS. 9A and 9B. In this case, Example 1-1 is the experimental result of Case 2-1, Example 1-2 is the experimental result of Case 2-2, and Example 1-3 is the experimental result of Case 2-3. Table 1 shows the operating time and the lowest voltage of the heating sheet 500 in the respective examples.

Referring to the following Table 1 and FIGS. 9A and 9B, the result of the evaluation experiment is as follows. In Case 2-1, the discharge time for which the battery voltage becomes 7.2 V (the operating time of the heating sheet 500) is 30 seconds or more. In Case 2-2, the discharge time for which the battery voltage becomes 7.2 V is approximately 30 seconds. In Case 2-3, the discharge time for which the battery voltage becomes 7.2 V is 10 seconds or less. In Case 2-1 and Case 2-2, there is no great difference in voltage of the battery for the discharge time. Consequently, it can be seen that the starting performance is better in Case 2-3 than in Case 2-1 and Case 2-2.

TABLE 1

| | | Operating Time | Lowest |
|---|---|---|---|
| | Heating | of | Voltage |
| | Sheet | Heating Sheet | (V) |
| Example 1-1 | No Heating | — | 7.09 |
| | Sheet | | |
| Example 1-2 | Attached | 30 seconds | 7.10 |
| | Outside Cell | | |
| Example 1-3 | Attached | 10 seconds | 7.90 |
| | Inside Cell | | |

Next, the experiment for evaluating the low-temperature charging performance of the battery cell according to the present disclosure was performed.

In this case, the battery cell according to the exemplary embodiment of the present disclosure was manufactured to have a capacity of 15 Ah, and a battery pack of 12 V and 60 Ah was manufactured by using the battery cell.

For evaluation, after the battery was completely discharged after measuring the capacity (0.5 C) of the battery, the battery was left unattended for 24 hours at a low temperature of −18° C. The current was checked while charging the battery at a low temperature. The current value was recorded for 30 seconds after starting the charging, and the current was checked up to 14.8 V at which the battery is fully charged. Thereafter, after the battery was left unattended for 24 hours at room temperature of 25° C., the capacity of the battery was measured.

As a result, the low-temperature charging performance was checked as shown in the following Table 2.

TABLE 2

| | | | | Battery |
|---|---|---|---|---|
| | | Operating | Current | Efficiency |
| | | Time of | Value | (Low- |
| | | Heating | (30 seconds | Temperature |
| | | Sheet | after | Capacity/Room- |
| | Heating | (Current = | Starting | Temperature |
| | Sheet | 30A (0.5 C.)) | Charging) | Capacity) |
| Example 2-1 | No Heating | Not | 81 A | 73% |
| | Sheet | Measured | | |
| Example 2-2 | Mounted | Initial 30 | 89 A | 74% |
| | outside | seconds | | |
| | Cell | | | |
| Example 2-3 | Mounted | 10 minutes | 119 A | 81% |
| | outside | (during | | |
| | Cell | operation) | | |
| Example 2-4 | Mounted | Initial 10 | 125 A | 87% |
| | inside Cell | seconds | | |

As shown in the above-mentioned Table 2, it can be ascertained that in Examples 2 to 4 (in which the heating sheet is positioned in the battery cell), the operating time of the heating sheet is shortest, the current value is highest, and the battery efficiency is highest. Accordingly, it can be ascertained that the charging performance is highest even at a low temperature when the heating sheet is positioned in the battery cell.

Next, the starting performance in accordance with the insulating film of the battery cell according to the present disclosure was checked.

The battery cell was manufactured by using a method identical to the method used to manufacture the battery cell in order to evaluate the above-mentioned starting performance, and the starting performance was evaluated while changing the thickness and the porosity of the insulating film.

After the battery was fully charged at room temperature, the battery was left unattended for 24 hours at a low temperature of −18° C., and then the heating sheet was operated by applying the current of 0.5 C, 30 A for 10 seconds. Thereafter, the voltage of the battery was checked while discharging the battery for one minute with a current of 650 A.

As a result of the checking, the lowest voltage was measured very low as 5.3 V when the thickness of the insulating film was 50 μm. Therefore, the thickness of the insulating film needs to be less than 50 μm. When the thickness is 8 μm, the lowest voltage is increased as the porosity of the insulating film is high, but the battery is short-circuited when the porosity of the insulating film is 70% or higher. Therefore, it can be seen that the porosity of the insulating film of 30% or higher is appropriate. Therefore, it is preferred that the thickness of the insulating film is 5 μm or more and 30 μm or less, and the porosity is 30% or higher.

According to the present disclosure configured as described above, the heating sheet is positioned in the battery cell, such that it is possible to utilize the lithium ion battery as a starting battery even in cold weather. The system and the structure of the battery cell can further quickly increase the internal temperature of the battery cell, thereby quickly activating the starting function even in a low-temperature environment.

In addition to the starting performance, the charging performance and the charging efficiency of the lithium ion battery also deteriorate at a low temperature. Therefore, the raising of the temperature of the battery cell within a short time improves the performance of the lithium ion battery, while the vehicle travels, while ensuring the starting function, thereby improving energy efficiency.

The above description is merely illustrative of the technical idea of the present disclosure, and those of ordinary skill in the art to which the present disclosure pertains will be able to make various modifications and variations without departing from the essential characteristics of the present disclosure.

Accordingly, the embodiments disclosed in the present disclosure are not intended to limit the technical idea of the present disclosure, but to explain the technical idea, and the scope of the technical idea of the present disclosure is not limited by these embodiments. The scope of protection of the present disclosure should be interpreted by the following claims, and all technical ideas within the scope equivalent thereto should be construed as being included in the scope of the present disclosure.

What is claimed is:

1. A battery cell comprising:
an inner wall;
battery electrodes arranged in the inner wall;
a separator configured to be in contact with the battery electrodes;
an electrolyte; and
a heating sheet comprising:
a heating unit positioned in the battery cell and configured to apply heat to increase ionic conductance of the electrolyte; and
insulating films configured to cut off electrical contact with the battery electrodes.

2. The battery cell of claim 1, wherein the heating unit comprises:
a heating element; and
heating unit electrodes including a metallic material having conductivity.

3. The battery cell of claim 2, wherein the heating unit electrode includes any one selected from the group consisting of gold, silver, copper, nickel, aluminum, platinum, palladium, tin, zinc, iron, lead, and an alloy thereof.

4. The battery cell of claim 2, wherein the heating element includes a carbon material.

5. The battery cell of claim 4, wherein the heating element is made of any one selected from the group consisting of CNT, graphite, carbon black, graphene, CNF, and a composite thereof.

6. The battery cell of claim 4, wherein the heating element is configured by being attached with a polymer binder.

7. The battery cell of claim 4, wherein the heating element is coated with the insulating films, and a ratio of a surface area of the heating element to that of the insulating film is 10% or more and 90% or less.

8. The battery cell of claim 2, wherein the heating element is made of a metallic material.

9. The battery cell of claim 8, wherein the metallic material of the heating element is any one selected from a group consisting of iron, copper, tungsten, nickel, chromium, and an alloy thereof.

10. The battery cell of claim 8, wherein the metallic material of the heating element is coated with an insulating polymer.

11. The battery cell of claim 10, wherein the insulating polymer is any one selected from the group consisting of PE, PI, PP, PET, and nylon.

12. The battery cell of claim 1, wherein the insulating film has a porous structure.

13. The battery cell of claim 12, wherein the insulating film has a thickness of 5 μm or more and 30 μm or less, and porosity of 30% or higher.

14. A system for controlling a battery cell embedded with a heating sheet, the system comprising:
a battery cell according to claim 1;
a temperature sensor configured to sense an internal temperature of the battery cell; and
a battery management system configured to receive a sensed value from the temperature sensor and configured to operate the heating sheet or stop an operation of the heating sheet.
